(19) United States
(12) Patent Application Publication
(10) Pub. No.: US 2021/0052975 A1
(43) Pub. Date: Feb. 25, 2021

(54) GAME SYSTEM AND GAME PROGRAM

(71) Applicant: SQUARE ENIX CO., LTD., Tokyo (JP)

(72) Inventors: Takamasa SHIBA, Tokyo (JP); Hiroshi KOBAYASHI, Tokyo (JP); Jun WAGA, Tokyo (JP)

(73) Assignee: SQUARE ENIX CO., LTD., Tokyo (JP)

(21) Appl. No.: 16/999,006

(22) Filed: Aug. 20, 2020

(30) Foreign Application Priority Data
Aug. 22, 2019 (JP) 2019-152145

(51) Int. Cl. A63F 13/216; A63F 13/5378; A63F 13/352; H04W 4/02; H04W 4/029; A63F 13/332

(52) U.S. Cl. CPC A63F 13/216; A63F 13/5378; A63F 13/332; H04W 4/027; H04W 4/029; A63F 13/352

(57) ABSTRACT

A game system and program include a game DB storing game data, a game server connected to the game DB, and a portable terminal having function of connecting to the game server via internet, and function of detecting its own positional information by receiving time signals from GPS satellites. When a player sets a target place moving from a player's own position in a real world and walks on a road in the real world to reach the target place, the system calculates and provides a reward based on a relationship between the target place and the player's own position according to a reward calculation function. In the case of setting an automatic response without player's operation (walk mode) to a game element previously arranged in a route, the system progresses a game only by the player's walking without paying close attention to a terminal screen of the portable terminal.

### CROSS-REFERENCE TO RELATED APPLICATION

The present application claims priority to Japanese Patent Application No. 2019-152145 filed on Aug. 22, 2019, the disclosure of which is expressly incorporated herein by reference in its entirety.

### TECHNICAL FIELD

The present invention relates to a game system and a game program which is preferable applied to a portable terminal such as a portable smartphone. More specifically, the present invention relates to a game system and a game program which can select a game difficulty at player's convenience and can improve a safety for a play based on a positional information during movement of a user holding a portable terminal, thereby encouraging an interest.

### BACKGROUND ART

In recent years, there has been provided a game program which utilizes a GPS function of a portable terminal such as a portable smartphone. For example, U.S. Pat. No. 9,226,106 and Japanese Patent Application Publication No. 2018-37051 describe a technology relating to the game program utilizing the GPS function of the portable terminal.

U.S. Pat. No. 9,226,106 describes a game technology which uses a positional information (latitude and longitude) of a real world based on a GPS function of a smartphone as a geographical information, and uses a virtual world geography making a motion and an action of a player in the real world affect an action in a virtual world in parallel to at least a part of a real world geography and affecting an inverse action thereto.

Japanese Patent Application Publication No. 2018-37051 describes a game technology which gives a reward by utilizing a positional information based on a GPS performance and checking in a location area such as an arbitrary store or facility on a map.

Further, in recent years, there has been widely used a game program in which a party constituted by a plurality of characters including a main character fight against an enemy evil entity while using a weapon such as a sword and a magic on the basis of an operation of a player, by connecting a game server and a portable terminal such as a smartphone via a communication network such as an internet.

### SUMMARY

The game system utilizing the positional information according to the prior art is structured such as to use the positional information (latitude and longitude) of the real world based on the GPS function as the geographical information, and reflect a movement on foot and an operation of the player in the real world on the virtual gaming world. In the game system according to the prior art, a game difficulty is previously set by a system side, and the game system includes a case that the player intends to positively participate in the game and a case that the player does not positively participate the game (distracted operation) according to personal circumstances. As a result, the player cannot select a game difficulty according to a player convenience.

Since the game difficulty cannot be selected, the player hesitates to participate in the game in a case where it is hard to positively participate in the game although the player intends to develop the main character. Therefore, the game system according to the prior art has a problem that the game system may discourage the player's interest in the game as a result.

Further, the game system according to the prior art has had an increased danger caused by a so-called using a smartphone while walking that a player during moving on foot pays attention to a screen of the portable terminal such as the smartphone. More specifically, in the game system according to the prior art structured such that the player conducts an operation while paying attention to the screen during the moving on food, a visual field of the player is narrowed, the visual field of the user under gaming is about one twentieth of the normal walking time, and the user can recognize an object only when the user comes close to the object at 1.5 m and is hard to view the surrounding. As a result, there has been possibilities of frequently generating a trouble such as contact with the surrounding pedestrian, road crossing due to a careless signal view or ignoring of a red light, occurrence of an accidental contact with a bicycle or a bike.

The technology described in each of U.S. Pat. No. 9,226,106 and Japanese Patent Application Publication No. 2018-37051 only has an effect of maintaining an amusement on the game by utilizing the positional information of the real world.

An object of the present invention is to achieve the problem caused by the prior art, and to provide a game system and a game program which can select a game difficulty according to a player's convenience and can improve a play safety on the basis of a positional information during movement of a user.

A game system and a game program according to the present invention includes a game database which stores arbitrary game data, a game server which is connected to the game database, and a portable terminal having a communication function which is connected to the game server via a communication line, a position detection function which detects a self-location information representing a self-location, a reward calculation function which calculates a reward on the basis of a relationship with a target place from the self-location, and a screen display function, in which when a player moves on a road in a real world reaching a target place while holding the portable terminal, the portable terminal displays that a main character moves along a route of a game map information in correspondence to the self-location in the real world, and accepts a game progress corresponding to a game element which is set in the route of movement and the target place.

The game database and/or the portable terminal has the game map information and an information table storing an element positional information which represents a landmark in the game map information and a position of the game element.

The portable terminal actualizes: a first step of detecting the self-location information on the basis of the position detection function; a second step of searching the positional information of a plurality of landmarks in a predetermined area beginning at the positional information detected by the first step from the information table; a third step of displaying the game map information arranging the arbitrary landmark searched by the second step as a target candidate according to a screen display function; a fourth step of setting a selection target candidate selected from the plurality of target candidates included in the game map information displayed by the third step as a target place; a fifth step of arranging a game element in the target place set by the fourth step; a sixth step of displaying the game map information including the target place arranged by the fifth step according to a screen display function; and a seventh step of determining self-arrival at the target place displayed by the sixth step, and calculating a reward on the basis of a relationship with the target place from the self-location according to the reward calculation function.

The game system and the game program according to the present invention can select the game difficulty and can improve the safety of the play on the basis of the positional information during the movement of the user.

### BRIEF DESCRIPTION OF DRAWINGS

FIG. 1 is a view for describing an overall structure of a game system which actualizes a game program according to an embodiment of the present invention;

FIG. 2A is a view for describing an example of a portable terminal screen according to the present embodiment;

FIG. 2B is a view for describing an example of the portable terminal screen according to the present embodiment;

FIG. 3A is a view for describing an example of the portable terminal screen according to the present embodiment;

FIG. 3B is a view for describing an example of the portable terminal screen according to the present embodiment;

FIG. 3C is a view for describing an example of the portable terminal screen according to the present embodiment;

FIG. 4 is a view showing a configuration example of a game DB according to the present embodiment;

FIG. 5A is a view showing an example of a landmark information table according to the present embodiment; FIG. 5B is a view showing an example of a player information table according to the present embodiment; FIG. 5C is a view showing an example of a reward calculation information table according to the present embodiment; FIG. 5D is a view showing an example of another reward calculation information table according to the present embodiment;

FIG. 6A is a flow chart showing an example of a whole operation of a game program according to the present embodiment;

FIG. 6B is a flow chart showing an example of the whole operation of the game program according to the present embodiment; and

FIG. 7 is a flow chart for describing an example of a reward calculation processing according to the present embodiment.

### DESCRIPTION OF EMBODIMENTS

[Overall Structure]

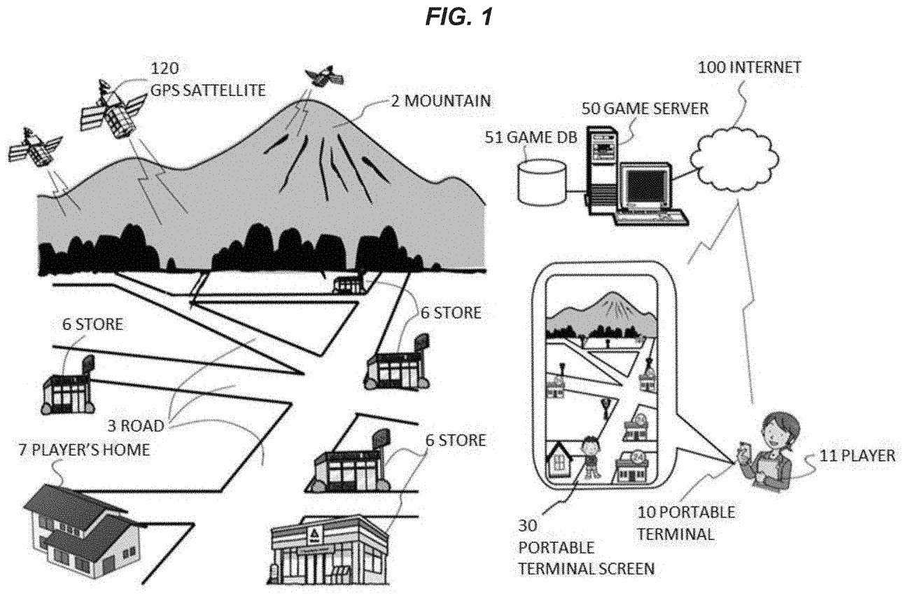

A game system according to an embodiment of the present invention is provided, for example, with a game DB (database) 51 which stores an arbitrary game data, a game server 50 which is connected to the game DB 51, and a portable terminal 10 such as a smartphone which has a function of connecting to the game server 50 via an Internet 100 corresponding to a communication line, and a function of detecting a self-location information (latitude and longitude), as shown in FIG. 1.

The portable terminal 10 is a hardware such as a general smartphone having a communication function which connects to the game server 50 via a communication line, a position detection function which detects a self-location information (latitude and longitude) on the basis of a signal and Wi-Fi signal information and mobile network base station information from a plurality of GPS satellites, a pedometer function which calculates steps of a holder, and a screen display function, and is installed therein a terminal game program operating in cooperation with a game program of the game server 50.

For example, in a case where the real world is such a geography that a plurality of stores 6 such as convenience stores are dotted as a landmark along a plurality of roads 3 crossing toward a faraway mountain 2 and the player's home 7 is disposed in a left near side as shown in a left side of FIG. 1, the game system displays a game screen on a portable terminal screen 30 while the player 11 moves on foot on the road 3 in the real world with holding the portable terminal 10, progresses the game by responding to the given game element, and acquires a reward.

The game element according to the present embodiment is, for example, “element appearing in in-game world”, and is divided, for example, into a major game element (main game element) such as an evil entity living in a forest and city set in a major quest (task) of the game, a tool (item) such as a small evil entity await in a road on the move and a herb pot arranged on the road, and an accessory game element (sub game element) such as a notice board. The main game element and the sub game element are not limited to the described examples, but are collectively called as the game element.

Further, the response to the game element according to the present embodiment is, for example, any action applied to the game element. In a case where the game element is the main game element, there can be listed up the matter that the main game element fights against the evil entity as the main quest subject and cleans up. In a case where the game element is the sub game element, there can be listed up the matter the sub game element fights (battles) against the evil entity encountering on the road, and the matter the sub game element takes an action (touches, picks up or reads) with respect to the tool (pot and notice board) put on the road. The response to the game element is not limited to them.

A game outline of the game system according to the present embodiment exists, for example, in the matter that the player 11 sets an arbitrary one store as a target place from a plurality of stores 6 shown in FIG. 1, and clears a main quest (task: for example, cleaning up the evil entity) given after moving on foot to the target place and reaching there, the matter that the player 11 cleans up the small evil entity lying in wait in the process of heading for the target place, and the matter that the player 11 takes an action (touches, picks up and reads) with respect to any tool (pot and notice board) arranged on the road, so that the player acquires any reward (experience point, coin, weapon or medical herb) and develops the main character. The reward acquired when reaching the target place and clearing the main quest in the present embodiment is a higher reward in the case of selecting a faraway target candidate in comparison with the case of selecting a near target candidate, and is also a higher reward by increasing the number of the tools such as the small evil entity and the pot encountering in the process of the long reaching distance. However, the reward is not limited to one which is based on the reaching distance, but may be previously set per target place, for example, in correspondence to a linear distance from the current place of the player 11 to the target place and distance or a difficulty level (great level difference or bypass requirement) to reach the target place. Further, the reward may be given to the arrival at the target place itself.

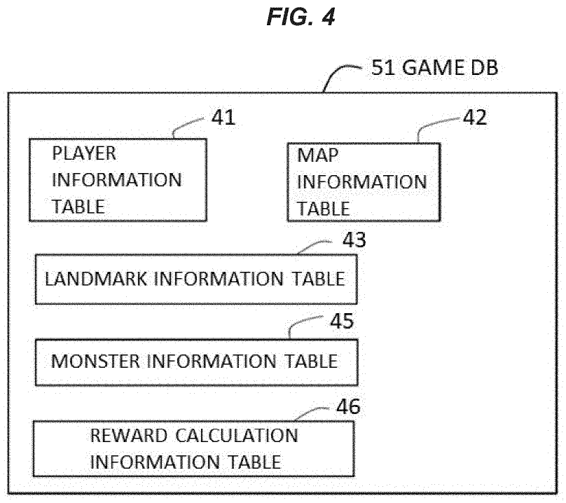

The game DB 51 is structured such as to store the game data required for progressing the game contents mentioned above, and is provided with tables listed below, for example, as shown in FIG. 4.

(1) A player information table 41 which stores information concerning a plurality of players playing the game.

(2) A map information table 42 which stores map information in the real world and landmark ID, name and positional information (latitude and longitude) such as the stores on the map.

(3) A landmark information table 43 which stores the landmark ID, name and positional information (latitude and longitude) such as the stores.

(4) A monster information table 45 which stores positional information of the game element appearing in response to the game progress, for example, the ID, name and attribute of the evil entity (monster) corresponding to the enemy character and the game element where the evil entity is arranged (also called as element positional information or element layout information, more specifically latitude and longitude information of the game element).

(5) A reward calculation information table 46 for calculating the reward given when clearing the quest.

(6) A plurality of kinds of information tables (not which are required for the other game progress.

(7) A memory (not shown) which stores a game program for a portable terminal operating in cooperation with the game program stored in the game server 50.

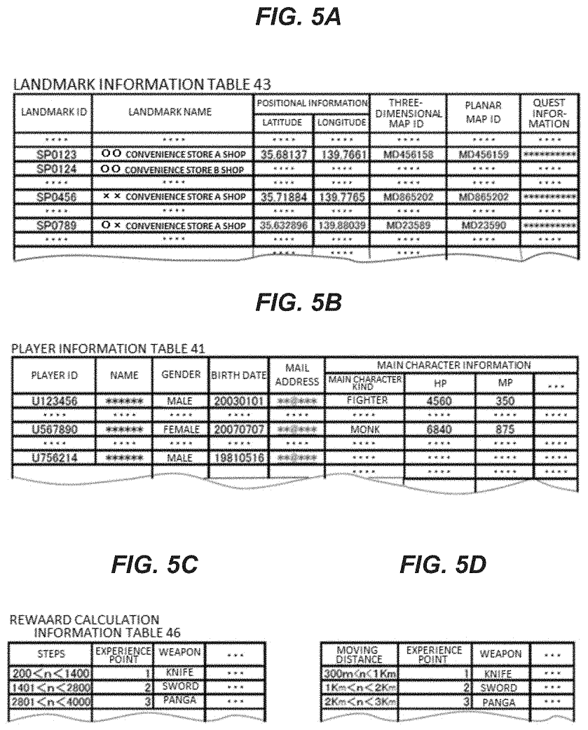

The landmark information table 43 stores the landmark ID which is given per landmark coming to a candidate for arranging the main game element such as a building and a building structure corresponding to a geographically characteristic object as a target on the real map, the name of each landmark, the latitude and longitude which is the positional information per landmark, a three-dimensional map ID and a two-dimensional map ID of the map information which are displayed on the portable terminal screen per landmark, the quest information concerning the major quest (task: for example, evil entity clean-up) which is given to the player in the target place, and the other plurality of kinds of item information (for example, map information drawn for displaying the screen prepared per specific map ID, not shown) concerning the landmark, as shown in FIG. 5A. The three-dimensional map ID mentioned above is the ID given to the three-dimensional map information for three-dimensionally displaying on the screen the map where the landmarks are dotted, and the two-dimensional map ID mentioned above is the ID given to the two-dimensional map information for widely displaying on the screen the map where the landmarks are dotted.

The player information table 41 stores a player ID which is given per a plurality of players, a name of each player, a gender of each player, a birth date of each player, a mail address of the player, and various information (main character kind, level, parameter such as HP: hit point and health point, MP: magic point, attribute and the like) concerning the main character (game character) set per player, as shown in FIG. 5B. The various information concerning the main character is updated on the basis of the reward which is given in correspondence to the clearing of the quest.

The reward calculation information table 46 is structured such as to store reward calculation information for calculating the reward when the player clears the major quest given in the target place in correspondence to the steps and the distance before the player reaches the target place by the selected moving on foot, and stores, for example, the steps n for calculating the reward on the basis of the steps, the experience point in correspondence to the steps n and the weapon, as shown in FIG. 5C. The illustrated reward calculation information table 46 shows an example in which the experience point “1” and the weapon “knife” are given as the reward in a case where the steps n is equal to or more 200 and less than 1400, and the experience point “2” and the weapon “sword” are given as the reward in a case where the steps n is equal to or more than 1401 and less than 2800.

Further, the reward calculation information table 46 according to the present embodiment is not limited to the table exemplified in FIG. 5C, but may be a table which stores a relative moving distance of the player, an experience point in correspondence to the moving distance and a weapon in correspondence to the moving distance, for example, as shown in FIG. 5D.

As mentioned above, in the present embodiment, an amount of movement (number of walks and distance) of a player 11 holding the portable terminal 10 can be measured by using the pedometer function and the position detection function of the portable terminal 10 mentioned above, and these functions are also called in the present application as a movement amount measurement function or a movement amount measurement means.

The game server 50 is a computer which is connected to the portable terminal 10 operated by the player 11 via the communication line such as the game DB 51 and the internet 100, and stores in a hard disc a game program controlling the process of the game on the basis of the operation and the positional information of the player 11 while referring to the various game information stored in the game DB 51.

[Outline of Action]

The game program according to the present embodiment is structured such as to give any reward (experience point, coin, weapon or medical herb) to the main character and develop the main character (levels up and increases various parameters) by the provision of at least functions listed up below.

(1) Function of allowing a player to select a game difficulty in relation to a game (low difficulty in a short distance and high difficulty in a long distance) among a plurality of target candidates based on a plurality of landmarks arranged on a virtual geography screen on which a real geography at the current position of the player is projected, by allowing an arbitrary setting of a target place to which the player moves on foot beginning at a self-location.

(2) Function of synchronizing a movement on foot in the real world from a current position of a player to a target place with a movement on foot of a main character on a virtual geography screen so as to display on a display screen of a portable terminal.

(3) Function of taking an action with respect to a sub game element arranged in a route heading for a target place (for example, function of cleaning up a small evil entity lying in wait and the other function for touching, picking up or reading a pot, a notice board and the like).

(4) Function of clearing a quest corresponding to a main game element set in a major quest (task: for example, cleaning up an evil entity).

As the reward when cleaning up the small evil entity lying in wait on the route, for example, giving an experience point and getting a weapon can be listed up. As the reward when taking an action on some game element arranged on the route, for example, restoring a physical strength by touching a medical herb and getting information can be listed up. Further, as the reward when clearing the task in the target place, giving an experience point, coin or weapon can be listed up.

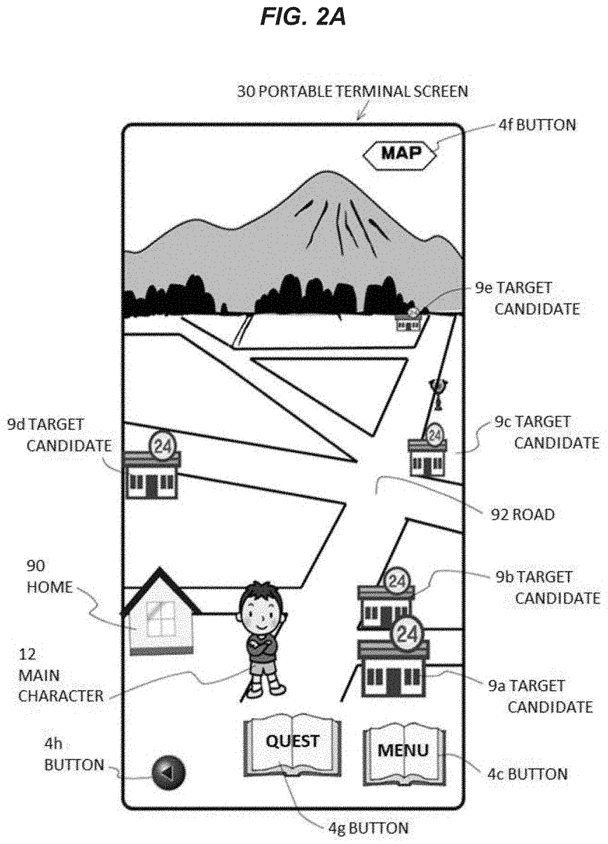

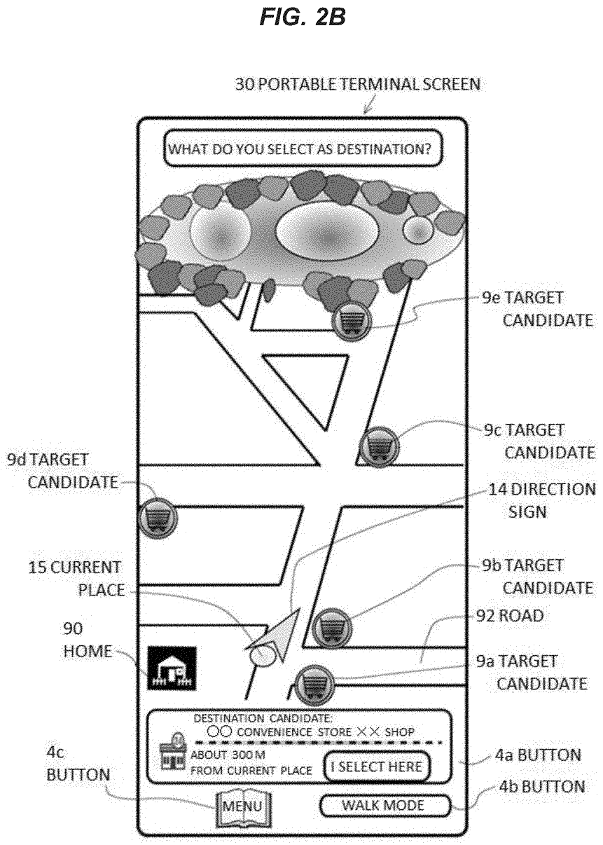

Further, the major quest (task) is a main task to be cleared which is given to the main character, for example, to fight against and clean up a specific evil entity (monster) in a specific place. The quest is given as “clean-up of an evil entity in OO village”, for example, by a player tapping a button 4g of “quest” on a display screen shown in FIG. 2A, and is started by a player reaching an arbitrarily selected target place. More specifically, in the present embodiment, it is possible to arbitrarily set a target place challenging a major quest where a main game element is arranged, on the basis of selection of the player.

In the game according to the present embodiment, the player can arbitrarily set a target place where the player moves on foot beginning at the self-location. Therefore, it is possible to select a game having a low difficulty (short time and low exercise volume) setting a short distance target place and a comparatively low reward, and a game having a high difficulty (long time and high exercise volume) setting a long distance target place and a comparatively high reward, in correspondence to the player's convenience, and it is possible to keep interest in the game. More specifically, the present game allows the player to select the game difficulty by making the game content to be selectable between the low difficulty and the high difficulty, and the player can casually participate in the game, so that it is possible to keep interest in the game.

[Description of Game Screen]

Next, a description will be given of an example of a display screen based on the game program according to the present embodiment.

FIG. 2A shows an example in which a portable terminal 10 displays on a portable terminal screen 30 a geographical information drawing a geography screen of a real world in an animation style on the basis of a positional information (latitude and longitude) which is calculated on the basis of a plurality of time signals received from a plurality of GPS satellites 120, for example, is an initial screen showing a three-dimensional map when starting a game.

The initial screen like the three-dimensional map displays target candidates 9a to 9e by which a plurality of stores (landmarks) such as convenience stores arranged along a plurality of roads crossing toward a faraway mountain are replaced, a main character 12 which is arranged at a position on a geography of a player 11, a home 90 which is arranged at an arbitrary position by the player and is a home of the main character 12, a button 4f for switching to a two-dimensional map display which is arranged in an upper right corner of the screen, a button 4h for turning back to a previous screen which is arranged in a lower end of the screen, a button 4g for switching to a quest (game task) display which is arranged in a lower end of the screen, and a button 4c for moving the other menu screen which is arranged in a lower end of the screen. The home 90 means the home of the main character, and may be a position of a residential place of the player 11 in the real world or an arbitrarily set position. The present game is automatically turned back to the home when the HP of the main character 12 is zero (died), and can improve an amusement by adding a function that the HP makes a comeback, or a function of changing an interior on the basis of selection of the player and inviting a friend.

FIG. 2B is a planar map screen for promoting the player 11 to select a target place when tapping the button 4g instructing the quest display on the initial screen shown in FIG. 2A. The planar map screen displays the target candidates 9a to 9e in which a plurality of stores such as the convenience stores arranged along a plurality of roads crossing toward the faraway mountain displayed by a plane are replaced as a candidate of the target place, a current place 15 which simply displays a position of the main character, a direction sign 14 which represents a direction of the main character, a button 4c for moving to the other menu screen, a button 4a which is a guide display for promoting the player 11 to select a destination from the target candidates, and a button 4h for setting “walk mode” which is a feature of the present embodiment.

“Walk mode” according to the present embodiment is a function of automatically responding to a sub game element which is previously arranged on a route in the process of moving (without any operation of the player) when the player 11 (main character 12) moves on foot in a fixed speed range from the current position to the target place (automatic response function).

As the sub game element, for example, there can be listed up a tool (item) such as a small evil entity awaiting in the route and a herb pot arranged in the route, a notice place and a character such as a village people, however, the sub game element is not limited thereto.

As the automatic response function to the sub game element, for example, there can be listed up fighting (battling) against the small evil entity in a case where the game element is the small evil entity awaiting in the route, picking up and searching a tool in a case where the game element is the tool, and reading a signboard and collecting information in a case where the game element is the signboard.

The reward at the target place in the present embodiment is, for example, an experience point, a coin, a weapon, a tool and a gacha ticket, and the reward in the case of selecting the faraway target candidate is set to a high reward. Further, the reward before reaching the target place comes to a high reward since the number of the sub game element encountering in the course is increased due to a long reach and a chance of acquiring the reward (tool such as experience point, coin, weapon and medical herb) is increased.

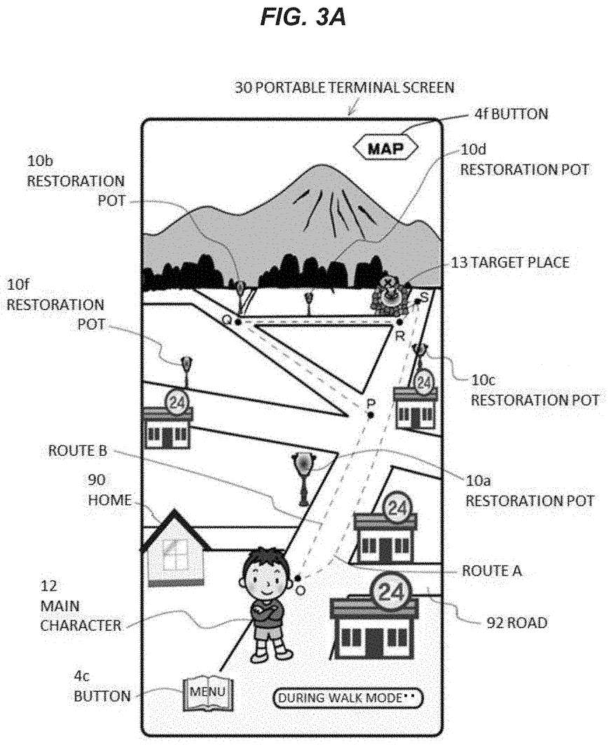

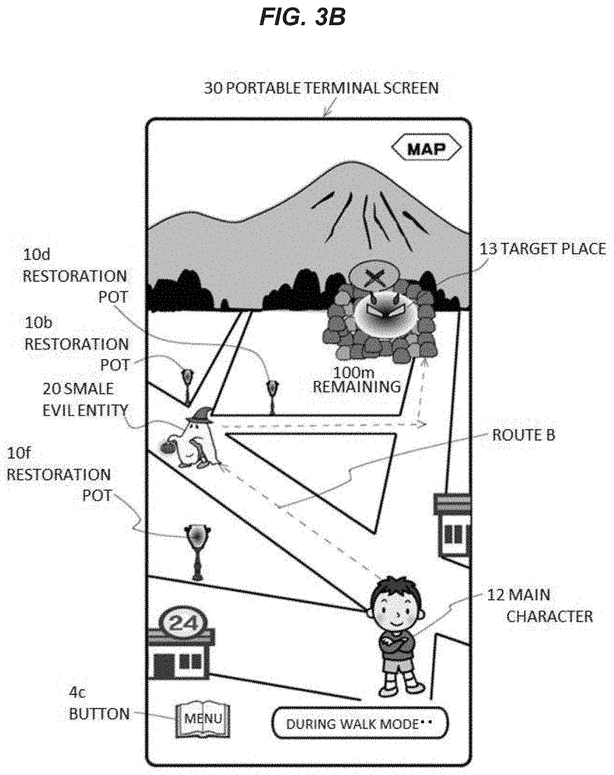

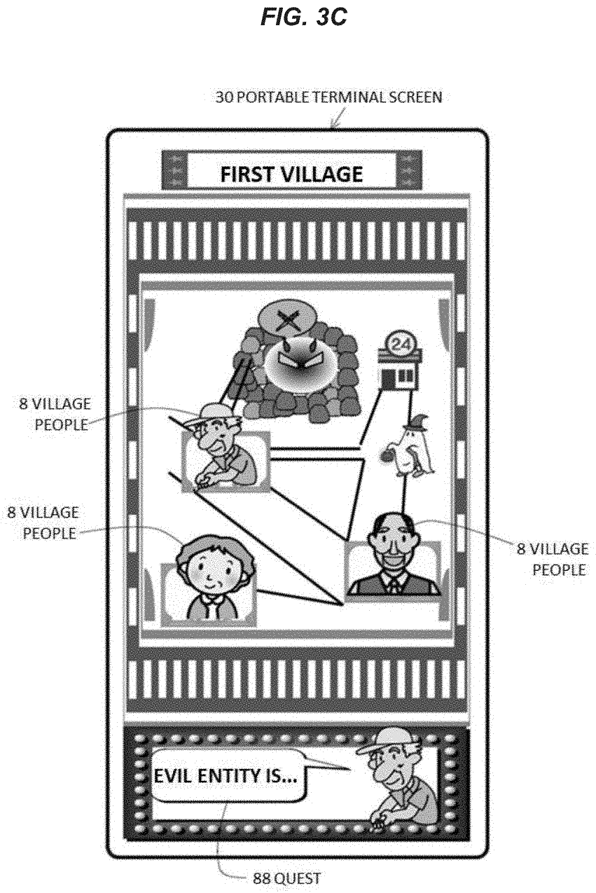

The game screen according to the present embodiment displays an animation style three-dimensional geography screen during the walk mode shown in FIG. 3A in a case where the player selects the arbitrary target point from a plurality of target candidates displayed on the planar map screen shown in FIG. 2B and sets the walk mode.

In the three-dimensional geography screen, restoration pots 10a to 10f for restoring a physical strength (HP) of the main character 12 in a predetermined range are arranged in the target place 13 and in the process of the routed as a place selected from the target candidates, and the player 11 starts moving to the faraway target place 13 on foot on the road in the real world. As a result, the three-dimensional geography screen changes so that the main character 12 moves toward the target place 13. As a movement route of the main character 12 according to the present embodiment, there can be thought a route A (route of dots O-S) in which the main character 12 linearly heads for the target place 13, and a route B (route of dots O-P-Q-R-S) in which the main character 12 bypasses in the middle.

Next, the display screen when the main character 12 linearly comes close to the target place 13 by the movement on foot of the player 11 is arranged at a position where the main character 12 comes close to the target place 13 as shown in FIG. 3B, and the small evil entity 20 and the pots 10b and 10d for restoration are arranged and displayed in the process of the bypassing route 9. The three-dimensional map screen and the planar map screen shown in FIGS. 2A to 3B are called as a map screen for game in the present application.

Next, in the display screen according to the present embodiment, a screen for transferring the quest to the main character 12 is displayed, for example, as shown in FIG. 3C, when the player 11 reaches the target place 13. In the exemplified display screen, a plurality of village people 8 corresponding to the people in the village which the main character reaches are displayed, the task to the main character 12 represented below the screen is displayed by tapping of the arbitrary village people 8, and the player 11 thereafter manipulates the main character 12 so as to clear the quest. As a result, the screen changes so that the reward is given.

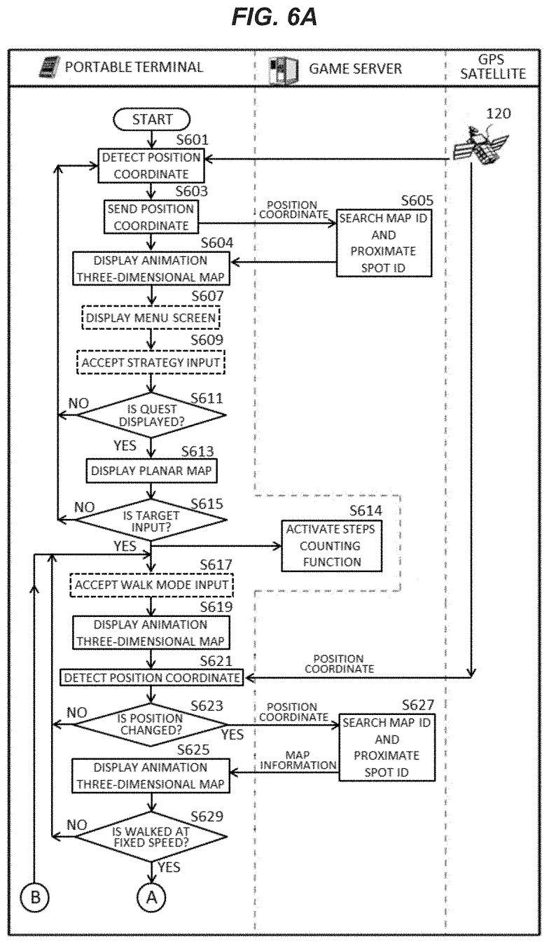

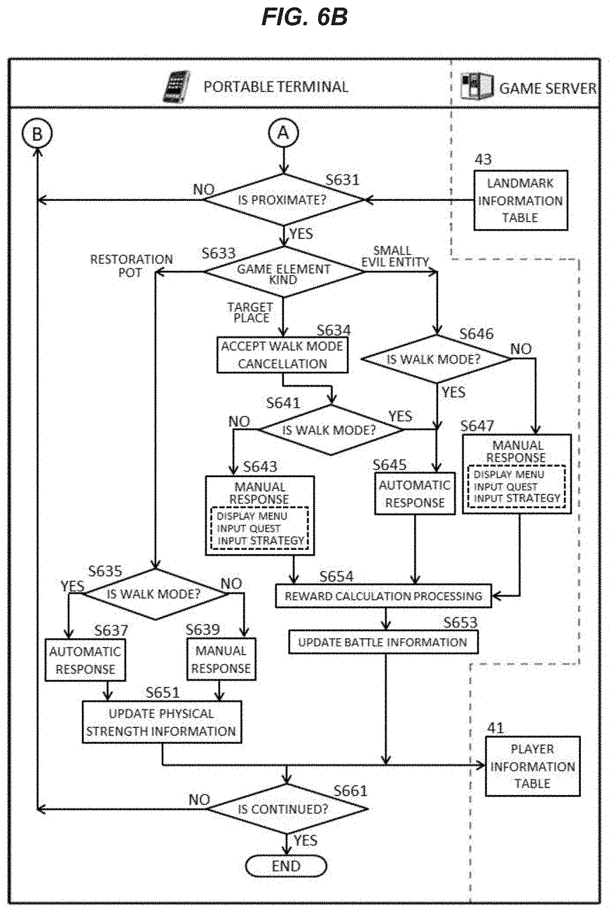

The game system and program to be subjected by the present embodiment is structured, as mentioned above, such that the player 11 moves on foot on the road 3 in the real world while holding the portable terminal 10, and the game screen is displayed on the portable terminal screen 30 while detecting the position change caused by the movement on foot, thereby progressing the game and acquiring the reward. In particular, in the game system and program according to the present embodiment, in a case where the player 11 mentioned above sets the walk mode (function of automatically responding to the sub game element previously arranged in the route in the process of moving without any player operation) when the player 11 moves on foot on the road in the real world, the player 11 can progress the game and acquire the reward only by moving on foot without paying close attention to the terminal screen 30 of the portable terminal. A description will be given of details of the action with reference to FIGS. 6A and 6B.

[Detail of Action in Walk Mode]

The game program and system according to the present embodiment is structured such that the portable terminal 10 detecting the self-location by receiving a time signal from a GPS satellite 120 controls the game progress mentioned above in cooperation with the game server 50. The portable terminal 10 or the game server 50 executes each of the following steps, whereby the player 11 can progress the game and acquire the reward only by moving on foot without paying close attention to the terminal screen 30 of the portable terminal in a case where the player 11 sets the walk mode.

Step S601: The portable terminal 10 detects the positional information (latitude and longitude) on the actual geography of the portable terminal 10 by receiving the time signal from a plurality of GPS satellites 120 after starting the game.

Step S603: The portable terminal 10 sends the positional information detected by the step S601 to the game server 50. Step S605: The game server 50 searches the map information stored in the map information table 42 and the landmark ID of the target candidate stored in the landmark information table 43 in the game DB 51 on the basis of the positional information sent by the step S603, and sends the hit map information and target candidate landmark ID to the portable terminal 10.

Step S604: The portable terminal 10 displays the map information and the target candidate on the portable terminal screen 30 on the basis of the map information and the target candidate landmark ID received by the step S605. The display screen displays the road 92, the main character 12 and a plurality of target candidates 9a to 9e on the animation style three-dimensional map, for example, as shown in FIG. 2A. However, the display screen may be a two-dimensional map.

Step S607: This step is executed by the arbitrary setting of the player 11, and the portable terminal 10 makes a transition, for example, to a display of a plurality of menus for setting the main character, setting a team and variously setting a shop, when the button 4c instructing the menu display is tapped in the step S604.

Step S609: This step is based on an arbitrary operation of the player 11, and the portable terminal 10 accepts the quest (task) from the system and accepts an input of a strategy (for example, defense priority and offense priority) by the player.

The steps S607 and S609 are processes which e executed by an operation of the player 11.

Step S611: This step determines whether or not the player 11 selects the display of the quest, and turns back to the step S601 when determining that the player 11 does not select.

Step S613: The portable terminal 10 displays a planar map screen promoting to select a target (destination) shown in FIG. 2B in a case where it is determined in the step S611 that the player 11 selects the display of the quest.

Step S615: Following the step S613, this step turns back to the step S601 in a case where the portable terminal 10 determines that any target place is not input as a result of determination whether or not the target place is selected from a plurality of target candidates.

Step S614: This step activates a pedometer function in a case where it is determined in the step S615 that the target place is selected. The step S614 is a process for calculating the reward when clearing the quest on the basis of the steps, and is not required when calculating a walking distance on the basis of the positional information, and when the reward is previously set in correspondence to a linear distance to the target place, or a distance or a difficulty (large height difference and necessity of bypassing) until reaching the target place.

Step S617: The portable terminal 10 accepts an input of a walk mode (start of an automatic response function with respect to the sub game element) in a case where it is determined in the step S615 that the target place is input. The step S617 is an arbitrary input (setting) by the player 11, and the player 11 may move on foot without accepting the input of the walk mode and make a transition to a step S619 mentioned later and thereafter. In the present application, the walk mode of automatically executing the response to the sub game element is called as an automatic executing function, a function of setting the walk mode (automatic executing function) is called as a setting function, and a function of cancelling the walk mode (automatic executing function) is called as a cancelling function.

Step S619: The portable terminal 10 three-dimensionally displays on a screen a map where the landmarks are dotted, for example, in an animation style as shown in FIG. 3B, following the step S617.

Step S621: The portable terminal 10 detects the positional information (latitude and longitude) on the actual geography of the portable terminal 10 by receiving time signals from a plurality of GPS satellites 120 following the step S615 or the step S619.

Step S623: The portable terminal 10 compares the positional information detected by the step S601 mentioned above with the positional information detected by the step S621, determines whether or not the position of the player 11 changes, sends the detected positional information to the game server 50 when determining that the position of the player 11 changes at a predetermined value or more (YES), and turns back to the step S617 when determining that the position of the player 11 does not change at a predetermined value or more (NO).

The description is given of the example that the position change is determined on the basis of the time signal from the GPS satellite 120. However, the present invention is not limited to this example. For example, the movement of the player 11 may be determined by determining the movement on foot and the moving direction of the player 11 using a three-dimensional acceleration sensor of the portable terminal and combining with a positional detection by a GPS signal, Wi-Fi signal and mobile network base station information.

Step S627: This step searches the map information stored in the map information table 42 of the game DB 51 and the landmark ID of the target candidate stored in the landmark information table 43 on the basis of the positional information received by the step S621 and sends the hit map information and target candidate landmark ID to the portable terminal 10, in a case where the game server 50 determines in the step S623 that the position of the player 11 changes (YES).

Step S625: The portable terminal 10 displays on the portable terminal screen 30 the map information and the target candidate on the basis of the map information and the target candidate landmark ID received by the step S627. In the display screen, for example, as shown in FIG. 3B, the target candidate 9e set as the destination is displayed as the target place 13 such as a forest implying the quest, and a state in which the main character 12 comes close to the target place 13 corresponding to the destination is displayed.

Step S629: Next, the portable terminal 10 according to the present embodiment determines whether or not the moving speed of the player 11 is in a fixed speed range corresponding to the walking speed, and the step turns back to the step S617 when determining that the moving speed is not in the fixed speed range (NO: high-speed moving time achieved by a bicycle, vehicle or transportation facility). More specifically, in the present embodiment, the step makes a transition to a step S631 mentioned later and progresses the game when determining that the moving speed of the portable terminal 10 held by the player 11 is in the fixed speed range corresponding to the walking speed (YES), and the step turns back to the step S617 for accepting the input of the walk mode when determining that the moving speed is not in the fixed speed range (NO).

The fixed speed range is set, for example, in a range between 2 km/h and 10 km/h, since an average walking speed of a child and an elderly person is between about 1 km/h and 3 km/h, and an average walking speed of an adult is between about 4 kin/h and 6 km/h. Further, the speed is detected by an acceleration sensor of the portable terminal 10.

Step S631: When determining in the step S629 that the moving speed of the player 11 is in the fixed speed range corresponding to the walking speed, the portable terminal 10 compares the positional information determined by the step S621 with the target landmark stored in the landmark information table 43 of the game DB 51 and the positional information of the small evil entity and the restoration pot stored in the monster information table 45, determines whether or not the player 11 (main character 12) comes close to the sub game element (small evil entity or restoration pot) in the predetermined area, and turns back to the step S617 when determining that the player 11 does not come close to the previously set predetermined area.

The determination in the present step S631 as to whether or not the player 11 (main character 12) comes close to the sub game element in the predetermined area is executed, for example, by determining whether or not the positional information (latitude and longitude) of the sub game element (evil entity or restoration pot) is positioned in a predetermined area range (for example, a circular plane range having a radius of 5 m) with a central focus on the positional information (latitude and longitude) by the GPS of the player 11 (main character 12).

Further, in the present embodiment, the description is given of the example of determining whether or not the player 11 comes close to the sub game element in the predetermined area. However, the predetermined range is not limited to be the fixed one. For example, the player 11 can come close to the position of the sub game element (evil entity and herb pot) by viewing the screen in a non-walk mode. in the meantime, the position of the sub game element (evil entity and herb pot) cannot viewed by the player 11 in the walk mode. Therefore, the predetermined range may be set to be larger in the walk mode in comparison with the non-walk mode, for example, for preventing a possibility that the player comes close to the game element from being lowered. Further, the amusement may be improved by making the predetermined range narrow in a case where the moving speed of the main character is high and making the predetermined range wide in a case where the moving speed is low, thereby exerting a change.

In the present embodiment, the description is given of the example that the step S631 downloads the positional information of the game element (landmark and evil entity) from the game DB 51. However, a download timing in the present invention is not limited to the timing of the step S631, but the positional information downloaded in the step S627 or the other timings may be set as a subject to be compared.

Further, in the present embodiment, the description is given of the example of determining whether or not the player 11 comes close to the sub game element by determining whether or not the sub game element is positioned in the predetermined range with a central focus CM the position of the player 11 (main character 12). However, the present invention is not limited to this, but may determine whether or not the player 11 comes close, on the basis of a method of determining whether or not the player 11 intrudes into a predetermined range with a central focus on the positional information of the sub game element or the other methods of determining whether or not the player 11 passes through a predetermined point of the road and determining whether or not the player 11 intrudes into a predetermined area such as a park and a square.

Step S633: In a case where it is determined in the step S631 that the player 11 comes close to the sub game element in the previously set predetermined range, the portable terminal 10 determines the kind of game element for determining whether the sub game element in which the subject coming close to the player 11 according to the step S631 is arranged in the process of the route is the small evil entity or the restoration pot or is not the sub game element (target place where the main game element is set).

The handling contents (battle, medical herb acquirement and physical strength restoration by touching the medical herb) to be responded by the player 11 is different according to the approaching sub game element (encountered small evil entity and pot). Therefore, the step S633 in the present example is shown as an example that the determination of the other than the target place is discriminated into two kinds. The kind of the sub game element may be three or more, and the contents for responding is three or more kinds in this case.

Step S635: In a case where the kind (the approaching subject) of the sub game element coming close in the step S633 is determined as the restoration pot, the portable terminal 10 determines whether or not the walk mode (automatic response function to the game element) is set in the step S617 mentioned above.

Step S637: In a case where it is determined in the step S635 that the walk mode (automatic response function with respect to the game element) is set, the portable terminal 10 automatically applies an automatic response (process of tapping a pot and acquiring a medical herb) to the subject.

Step S639: In a case where it is determined in the step S635 that the walk mode (automatic response function with respect to the game element) is not set, the portable terminal 10 promotes to make the player 11 respond to the coming close to the game element via a vibration or a sound (tap the pot and acquire the medical herb).

Step S651: The portable terminal 10 updates a physical strength information which is a result corresponding to the game element (restoring the HP by acquiring the medical herb of the pot) in the step S637 or the step S639 with respect to the player information table 41.

Step S634: In a case where it is determined in the step S633 the approaching game element is not the sub game element (target place where the main game element is set), the portable terminal 10 accepts an input for cancelling the setting of the walk mode (automatic response function with respect to the game element). The step S634 is an arbitrary operation (setting) executed by the player 11, and may make a transition to the next step S641 without accepting the cancellation of the walk mode.

In the present embodiment, the description is given of the example that the input for cancelling the setting of the walk mode (automatic response function with respect to the game element) is accepted by the operation of the player in the step S634. However, the present invention is not limited to this, but may be structured such as to automatically cancel the walk mode, inform the player 11 of arrival at the target place and promote to manually respond, in a case where it is determined that the player 11 comes close to the target place where the main game element is set. In this example, the contents of the step S634 is changed to “process for cancelling a walk mode”, the determination in a step S641 is deleted, and the step makes a transition to a step S643 when it is determined by the step S633 that the game element is the target place.

Step S641: The portable terminal 10 determines whether or not the walk mode (automatic response function with respect to the game element) is set in the step S617 following the step S634 mentioned above.

Step S643: In a case where it is determined in the step S641 that the walk mode (automatic response function with respect to the game element) is not set, the portable terminal 10 responds to the quest (main game element) which is given in the target place by a manual operation of the player 11. As the step S463, for example, there can be listed up asking a quest from a village people, inputting a strategy when making a transition to a menu display and clearing a quest, and clearing an asked quest (main game element).

Step S645: In a case where it is determined in the step S641 that the walk mode (automatic response function with respect to the game element) is set, the portable terminal 10 automatically responds to a game element (evil entity) without depending on an operation of the player 11.

Step S646: In a case where it is determined in the step S633 that the approaching game element (the approaching subject) is an awaiting small evil entity, the portable terminal 10 determines in the step S617 mentioned above whether or not the walk mode (automatic response function with respect to the game element) is set, and the step makes a transition to a step S645 when determining that the walk mode is set.

Step S647: In a case where it is determined in the step S646 that the walk mode (automatic response function with respect to the game element) is not set, the portable terminal 10 responds to the sub game element (small evil entity) by a manual operation of the player 11. As the step S647, for example, there can be listed up battling against the encountering sub game element (small evil entity).

In the present embodiment, the description is given of the example that the walk mode is cancelled when coming close to the game element in a state in which the walk mode is set. However, the present invention may be structured such that the walk mode is not automatically cancelled even when coming close to the game element by deleting the determination according to the step S641 and the step S646 whether the walk mode is set, and the automatic response according to the step S645.

Step S654: The portable terminal 10 calculates a reward in response to results of executing the step S643, the step S645 and the step S647 (results of responding to [clearing or not clearing] the main and sub game elements [quest, evil entity and pot]) and the steps to the target place or the walking distance. Details of the reward calculation technology will be mentioned later.

Step S653: The portable terminal 10 updates a player information based on the reward which is calculated by the step S654.

Step S661: Following the step S651 and the step S653, this step determines whether or not a game is continued according to an operation of a player 11, finishes the game when the game end is determined, and turns back to the step S619 mentioned above when the game is determined to be continued and three-dimensionally displays on a screen a map where the landmarks are dotted, for example, in an animation style as shown in FIG. 3B.

[Reward Calculation Method]

A method of calculating the reward based on the steps according to the quest result by the step S654 calculates by measuring the steps after starting the steps counting function according to the step S614 before determining in the step S633 that the approaching game element is the target place, and referring to the reward (experience point and weapon) with respect to the steps stored in the reward calculation information table 46 shown in FIG. 5C.

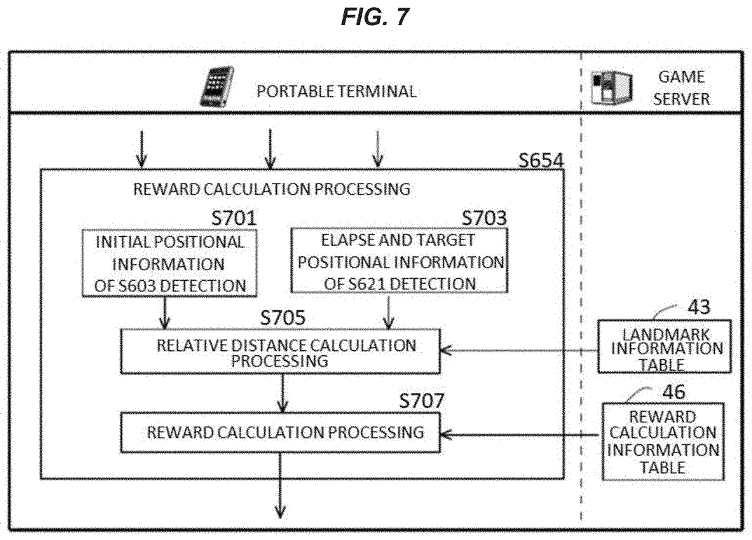

Further, a method of calculating the reward based on the moving distance calculates a reward in correspondence to a moving distance by measuring a moving distance of the player 11 on the basis of a step S701 in which the portable terminal 10 acquires the positional information in an initial time (at a starting point) calculated by the step S603, a step S703 of acquiring the positional information in the process of the route detected by the step S621 and the positional information when reaching the target point, a plurality of positional information to the starting point, the middle point and the reaching point acquired by the steps S701 and S703 and the positional information and map information stored in the landmark information table 43, as shown in FIG. 7, in a case where the position detection function of the portable terminal 10 mentioned above is used.

For example, in the case of the route B shown in FIG. 3A, a moving distance of the player 11 is measured by adding a distance between points O and P, a distance between points P and Q, a distance between points Q and R and a distance between points R and S beginning at a point O, and the reward (experience point and weapon) with respect to the distance stored in the reward calculation information table 46 shown in FIG. 5D is referred and calculated. A method of measuring an amount of movement on the basis of the positional information is not limited to the example mentioned above, but may be performed, for example, by measuring and storing the positional information every fixed time (for example, every one minute) by the portable terminal and adding the distances between the positional information from the measurement starting point to the target place.

Further, the reward calculating method according to the present invention is not limited to the example mentioned above, but may calculate a linear distance between the starting point and the reaching point and calculate the reward on the basis of the linear distance, or may give the reward for the arrival itself at the target place even if the game is not cleared, for example. The reward calculation method according to the present invention is structured as mentioned above such as to calculate the reward on the basis of a relationship with the self-location to the target place, for example, a linear distance between the moving distance, the steps and the self-location of the player 11 and the target place.

As mentioned above, in the game system and the game program according to the present invention, the player can arbitrarily set a target place to which the player moves on foot beginning at the self-location. As a result, it is possible to select a low difficulty (low level: short time and low exercise volume) and comparatively low reward game in which a short distance target place is set, a high difficulty (high level: long time and high exercise volume) and comparatively high reward game in which a long distance target place is set, and a plurality of medium difficulty games between the high difficulty and the low difficulty, at player's convenience, so that it is possible to select the game difficulty and maintain the interest in the game.

Further, in the game system and the game program according to the present invention, when the player moves on foot from the self-location to the target place, the player can automatically continue the game without paying close attention to the screen during moving on foot under gaming, by employing “walk mode” which is a process (automatic response function) of automatically responding to the game element previously arranged in the route in the process of moving (without any operation of the player), and it is possible to reduce a possibility that such troubles as a contact with a peripheral pedestrian, a road crossing with careless signal viewing, ignorance of a red light, and an accidental contact with a bicycle occur. More specifically, the present invention can also improve a safety of the play on the move on the basis of the positional information of the player. The positional detection function of the portable terminal is not limited to be based on the GPS signal, and mobile network base station information, but may be based on the other methods.

1. A game system comprising:
a game database configured to store game data;
a game server configured to be connected to the game database;
a portable terminal configured to:
connect the portable terminal to the game server via a communication line;
detect position information representing a self-location;
calculate a reward on the basis of a relationship with a target place from the self-location; and
cause the portable terminal to display that a main character moves along a route of game map information as a player moves on a road in a real world reaching a target place while holding the portable terminal,
wherein the portable terminal is configured to accept a game progress corresponding to a game element which is set in the route of movement and the target place,
wherein at least one of the game database or the portable terminal has the game map information and an information table configured to store a landmark in the game map information and element positional information which represents a position of the game element,
wherein the portable terminal is configured to:
detect the positional information on the basis of the position detection function;
search positional information of a plurality of landmarks in a predetermined area starting at the detected positional information from the information table;
display the game map information arranging the plurality of landmarks as a plurality of target candidates according to the screen display function;
set a selected target candidate selected from the plurality of target candidates included in the displayed game map information as the target place;
arrange the game element in the target place:
display the game map information including the target place according to the screen display function; and
determine self-arrival at the displayed target place, and calculating a reward on the basis of a relationship with the target place from the self-location according to the reward calculation function.

2. A game system, comprising:
a game database configured to store game data;
a game server configured to be connected to the game database; and
a portable terminal configured to:
connect the portable terminal to the game server via a communication line;
detect a self-location information representing a self-location, and
measure an amount of movement of a holder,
wherein the portable al is configured to display that a main character moves along a route of a game map information in correspondence to the self-location in the real world, and further configured to accept a game progress corresponding to a game element which is set in the route of movement and the target place, when a player moves on a road in a real world reaching a target place while holding the portable terminal,
wherein at least one of the game database or the portable terminal has the game map information and an information table configured to store element positional information which represents a landmark in the game map information and a position of the game element,
wherein the portable terminal is configured to:
detect the self-location information on the basis of the position detection function;
search positional information of a plurality of landmarks in a predetermined area start at the detected self-location from the information table;
display the game map information arranging the plurality of landmarks as a plurality of target candidates;
set a selected target candidate selected from the plurality of target candidates included in the displayed game map information as the target place;
arrange a game element in the target place;
display the game map information including the target place;
determine self-arrival at the target place, and accepting a game progress in correspondence to the game element arranged in the target place;
measure an amount of movement from detecting the self-location information until reaching the target place on the basis of the movement amount measurement function when clearing the game is accepted as the game progress; and
calculate a reward in correspondence to the amount of movement.

3. The game system according to claim 2, wherein one of the game database or the portable terminal is configured to arrange the game map information and a plurality of game elements on the route from the self-location represented by the detected self-location information to the target place,
wherein the portable terminal is further configured to:
automatically execute responding to the game elements;
set the automatic executing function; and
cancel the automatic executing function upon detecting that the self-location is within the predetermined range from to the position of the game element to approach.

4. The game system according to claim 3, further comprising an acceleration sensor in the portable terminal,
wherein the movement amount measurement function is configured to measure steps of the holder by the acceleration sensor, and
wherein the game system is further configured to measure the steps from the detected self-location to the target place as an amount of movement.

5. The game system according to claim 4, wherein the portable terminal is further configured to detect a moving speed of the portable terminal, and further configured to disable automatically responding to the game element when the moving speed detected by the speed detection function is higher than a predetermined moving speed.

6. The game system according to claim 4, wherein the portable terminal is configured to set a predetermined range for determining that the self-location becomes close to the position of the game element larger while executing the setting function, than while executing the cancelling function.

7. The game system according to claim 5, wherein the portable terminal is configured to set a predetermined range for determining that the self-location becomes close to the position of the game element larger while executing the setting function than while executing the cancelling function.

8. The game system according to claim 4, wherein the portable terminal is configured to cancel the automatic executing function by the cancelling function when determining that the self-location comes close to the position of the game element set to the target place.

9. The game system according to claim 5, wherein the portable terminal is configured to cancel the automatic executing function by the cancelling function when determining that the self-location comes close to the position of the game element set to the target place.

10. The game system according to claim 6, wherein the portable terminal is configured to cancel the automatic executing function by the cancelling function when determining that the self-location of the portable terminal comes close to the position of the game element set to the target place.

11. A non-transitory computer-readable medium including a game program causing a computer to execute functions of controlling progress of a video game based on an operation input of a user, the functions comprising:
a game database function of configuring a game database and storing game data in the game database;
a communication function of connecting a portable terminal via a communication line to a game server that is configured to be connected to the game database;
a position detection function of detecting self-location information representing a self-location; and
a movement amount measurement function of measuring an amount of movement of a holder,
wherein the game program is configured to cause the portable terminal to display that a main character moves along a route of game map information in correspondence to the self-location in the real world, and further causes a computer of the portable terminal to execute a game corresponding to a game element which is set in the route of movement and a target place, when a player moves on a road in a real world reaching the target place while holding the portable terminal,
wherein at least one of a game database in the program or the portable terminal has the game map information and an information table configured to store an element positional information which represents a landmark in the game map information and a position of the game element,
wherein the game program is configured to cause the portable terminal to execute:
detecting the self-location information on the basis of the position detection function;
searching positional information of a plurality of landmarks in a predetermined area starting at the detected self-location from the information table;
displaying the game map information arranging the plurality of landmarks as a plurality of target candidates;
setting a selection target candidate selected from the plurality of target candidates included in the displayed game map information as a target place;
arranging a game element in the target place;
displaying the game map information including the target place;
determining self-arrival at the target place, and accepting a game progress in correspondence to the game element arranged in the target place;
measuring an amount of movement from detecting the self-location information until reaching the target place on the basis of the movement amount measurement function when clearing the game is accepted as the game progress; and
calculating a reward in correspondence to the amount of movement.

12. The non-transitory computer-readable medium according to claim 11, wherein the game program is further configured to cause at least one of the game database or the portable terminal to arrange the game map information and a plurality of game elements on the route from the detected self-location to the target place in the game map information,
wherein the game program is further configured to cause the portable terminal to execute:
an automatic executing function of automatically executing responding to the game elements;
a setting function of setting the automatic executing function; and
a cancelling function of cancelling the automatic executing function when it is detected that the self-location is within the predetermined range from the position of the game element to approach.

13. The non-transitory computer-readable medium according to claim 12, wherein the game program is further configured to cause the portable terminal to execute the movement amount measurement function that is configured to measure steps of the holder by an acceleration sensor in the portable terminal, and
wherein the movement amount measurement function is configured to measure the steps from the detected self-location to the target place as an amount of movement.

14. The non-transitory computer-readable medium according to claim 13, wherein the game program is further configured to cause the portable terminal to include a speed detection function of detecting a moving speed of the portable terminal, and further configured to disable the portable terminal automatically responding to the game element when the moving speed detected by the speed detection function is higher than a predetermined moving speed.

15. The non-transitory computer-readable medium according to claim 13, wherein the game program is further configured to cause the portable terminal to set a predetermined range for determining that the self-location becomes close to the position the game element larger while executing the setting function, than while executing the cancelling function.

16. The non-transitory computer-readable medium according to claim 14, wherein the game program is further configured to cause the portable terminal to set a predetermined range for determining that the self-location becomes close to the position of the game element larger while executing the setting function than while executing the cancelling function.

17. The non-transitory computer-readable medium according to claim 14, wherein the game program is further configured to cause the portable terminal to cancel the automatic executing function by the cancelling function when determining that the self-location of the portable terminal becomes close to the position of the game element set to the target place.

17. The non-transitory computer-readable medium according to claim 14, wherein the game program is further configured to cause the portable terminal to cancel the automatic executing function by the cancelling function when determining that the self-location of the portable terminal becomes close to the position of the game element set to the target place.

18. The non-transitory computer-readable medium according to claim 15, wherein the game program is further configured to cause the portable terminal to cancel the automatic executing function by the cancelling function when determining that the self-location of the portable terminal become close to the position of the game element set to the target place.
